(19) United States
(12) Patent Application Publication
(10) Pub. No.: US 2025/0157195 A1
(43) Pub. Date: May 15, 2025

(54) METHOD AND APPARATUS WITH OBJECT DETECTION MODEL TRAINING

(71) Applicants: SAMSUNG ELECTRONICS CO., LTD., Suwon-si (KR); Korea University Research and Business Foundation, Seoul (KR)

(72) Inventors: Sujin JANG, Suwon-si (KR); Sangpil KIM, Seoul (KR); Jinkyu KIM, Seoul (KR); Won Jeong RYOO, Seoul (KR); Dongwook LEE, Suwon-si (KR); Gyusam CHANG, Seongnam-si (KR); Dae Hyun JI, Suwon-si (KR)

(73) Assignees: SAMSUNG ELECTRONICS CO., LTD., Suwon-si (KR); Korea University Research and Business Foundation, Seoul (KR)

(21) Appl. No.: 18/897,759

(22) Filed: Sep. 26, 2024

(30) Foreign Application Priority Data
Nov. 10, 2023 (KR) 10-2023-0155437
Mar. 7, 2024 (KR) 10-2024-0032793

(51) Int. Cl. G06V 10/774; G06V 10/77

(52) U.S. Cl. CPC G06V 10/774; G06V 10/7715

(57) ABSTRACT

A processor-implemented method including text-guided training using a pre-trained text-guided model and an image feature extractor based on one or more text inputs and one or more image inputs corresponding to the one or more text inputs, light detection and ranging (LiDAR)-guided training using a point cloud encoder and a bird's-eye view (BEV) encoder, and training an object detection model based on a result of the text-guided training and a result of the LiDAR-guided training, and the text-guided training includes outputting one or more text-image features that are used to train the object detection model by using the text-guided model and the image feature extractor.

### CROSS-REFERENCE TO RELATED APPLICATIONS

This application claims the benefit under 35 USC § 119 (a) of Korean Patent Application No. 10-2023-0155437, filed on Nov. 10, 2023, and Korean Patent Application No. 10-2024-0032793, filed on Mar. 7, 2024, in the Korean Intellectual Property Office, the entire disclosures of which are incorporated herein by reference for all purposes.

### BACKGROUND

### 1 Field

The following description relates to a method and apparatus with object detection model training.

### 2. Description of Related Art

Recently, the introduction of computer vision technology using various sensors (e.g., light detection and ranging (LiDAR), radio detection and ranging (RADAR), or a multi-view camera) has rapidly advanced object detection and related research. Three-dimensional (3D) object detection technology may play a core role in recognizing the size, position, and classification of objects. Specifically, the depth information of an object in a three-dimensional space may be predicted by using a high-precision LiDAR sensor. However, using a high-precision LiDAR sensor presents a high cost, and thus, it may be necessary to develop technology that may replace LiDAR sensors. Multi-view camera technology is a method of processing multi-angle images simultaneously by installing cameras in various directions of a vehicle and may be effective in projecting 2D images onto a 3D bird's-eye view (BEV) space.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including text-guided training using a pre-trained text-guided model and an image feature extractor based on one or more text inputs and one or more image inputs corresponding to the one or more text inputs, light detection and ranging (LiDAR)-guided training using a point cloud encoder and a bird's-eye view (BEV) encoder, and training an object detection model based on a result of the text-guided training and a result of the LiDAR-guided training, and the text-guided training includes outputting one or more text-image features that are used to train the object detection model by using the text-guided model and the image feature extractor.

The outputting the one or more text-image features may include outputting camera-variant information by performing semantic information encoding on the one or more text inputs through a text encoder and a first projection layer model, which are included in the text-guided model and generating the one or more text-image features by adding one or more image features extracted by the image feature extractor to the camera-variant information.

The LiDAR-guided training may include performing contrastive training on LiDAR BEVs obtained from the point cloud encoder and image BEVs generated based on the BEV encoder.

The contrastive training may include training a cross-correlation of the LiDAR BEVs and the image BEVs based on a second loss function.

The training the object detection model may include updating one or more of the image feature extractor, a depth extractor, the BEV encoder, and a detection head, based on one of the one or more text-image features or a result of the contrastive training.

The depth extractor may be configured to generate first depth information based on the one or more text-image features and the depth extractor may be updated based on the first depth information, second depth information generated from a depth extraction point cloud, and a depth loss function.

The BEV encoder may be configured to generate the image BEVs based on a synthetic image feature generated based on a depth feature extracted by using the depth extractor and the one or more text-image features.

The method may include text-guided model training to obtain the pre-trained text guided model, the text-guided model training including updating a second projection layer model to a first projection layer model by using a text encoder, the second projection layer model, and an image encoder.

The text-guided model training may include extracting a text feature for training, the text feature including camera-variant information for training, from a training text input by using the text encoder and the second projection layer model and projecting the extracted text feature for training onto a shared embedding space, extracting an image feature for training from a training image input by using the image encoder and projecting the extracted image feature for training onto the shared embedding space, and updating the second projection layer model to the first projection layer model.

The updating the second projection layer model may include performing contrastive alignment training on the text feature for training and the image feature for training in the shared embedding space and training the second projection layer model to the first projection layer model by using a result of the contrastive alignment training and a first loss function.

The first loss function may include a camera classifier configured to suppress unclear geometric noise in the text feature for training.

In a general aspect, here is provided a non-transitory computer-readable storage medium storing instructions that, when executed by the one or more processors, configure the one or more processors to perform a text-guided object detection model, the text guided object detection model including a pre-trained text-guided model configured to generate camera-variant information from a text-image pair, an image feature extractor configured to extract an image feature from the text-image pair, a depth extractor configured to extract depth information based on the image feature, a BEV encoder configured to generate an image bird's-eye view (BEV) based on the camera-variant information, the image feature, and the depth information, and a detection head configured to perform object detection based on the image BEV.

In a general aspect, here is provided an electronic apparatus including one or more processors configured to drive a pre-trained text-guided model, an image feature extractor, a bird's-eye view (BEV) encoder, a light detection and ranging (LiDAR)-guided model, which includes a point cloud encoder, and a detection head and a memory storing instructions, and an execution of the instructions configures the processors to receive one or more text inputs and one or more image inputs corresponding to the one or more text inputs and output one or more text-image features used to train an object detection model by using the pre-trained text-guided model and the image feature extractor and train the object detection model based on the one or more text-image features and a result of the LiDAR-guided model.

The pre-trained text-guided model may be configured to generate one or more pieces of camera-variant information by performing semantic information encoding on the one or more text inputs through a text encoder and a first projection layer model and the one or more text-image features are generated by adding one or more image features extracted by the image feature extractor to the one or more pieces of camera-variant information.

The LiDAR-guided model may include a model configured to perform contrastive training on LiDAR BEVs obtained from the point cloud encoder and image BEVs obtained from the BEV encoder.

The contrastive training may include training the object detection model by training a cross-correlation of the LiDAR BEVs and the image BEVs based on a second loss function.

The one or more processors may be configured to update one or more of the image feature extractor, a depth extractor, the BEV encoder, and a detection head, based on the one or more text-image features or a result of the contrastive training.

In a general aspect, here is provided an electronic apparatus including one or more processors including a text encoder, a second projection layer model, and an image encoder and a memory storing instructions, and an execution of the instructions, configures the processors to extract a text feature, which includes camera-variant information, from text by using the text encoder and the second projection layer model and project the extracted text feature onto a shared embedding space, extract an image feature from an image by using the image encoder and project the extracted image feature onto the shared embedding space, and obtain a pre-trained text-guided model by updating the second projection layer model to a first projection layer model.

The obtaining the pre-trained text guided model may include performing contrastive alignment training on the text feature and the image feature in the shared embedding space and training the second projection layer model to the first projection layer model by using a result of the contrastive alignment training and a first loss function.

The first loss function may include a camera classifier configured to suppress unclear geometric noise in the text feature for training.

Other features and aspects will be apparent from the following detailed description, the drawings, and the claims.

### BRIEF DESCRIPTION OF THE DRAWINGS

FIGS. 1A to 1C illustrate example methods of training an object detection model according to one or more embodiments.

FIG. 2 illustrates an example method of a text-guided model training apparatus according to one or more embodiments.

FIG. 3 illustrates an example object detection model training apparatus according to one or more embodiments.

FIG. 4 illustrates an example pre-training operation of the text-guided model training apparatus according to one or more embodiments.

FIG. 5 illustrates an example operation of the object detection model training apparatus according to one or more embodiments.

FIG. 6 illustrates an example electronic device according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

The examples may be implemented as various types of products, such as, for example, a personal computer (PC), a laptop computer, a tablet computer, a smartphone, a television (TV), a smart home appliance, an intelligent vehicle, a kiosk, and a wearable device. Hereinafter, embodiments will be described in detail with reference to the accompanying drawings. When describing the embodiments with reference to the accompanying drawings, like reference numerals refer to like elements and a repeated description related thereto will be omitted.

Recently, multi-view camera-based 3-dimensional (3D) object detection has been implemented through bird's-eye view (hereinafter, BEV) technology. Object detection models mounted to certain electronic devices (e.g., autonomous vehicles, etc.) may be fixed in certain environments due to the qualitative/quantitative limitations of data. Specifically, object detection may be difficult, and performance may be degraded in environments (e.g., bad weather or night) with low visibility or unlearned environments.

A BEV refers to a viewpoint where an object is viewed from above. This term may be mainly used for a visual representation where an object or a scene is viewed from above in 3D computer vision or a camera system that provides a 360-degree view of the surroundings of a vehicle.

To prevent the degradation of the performance of such an object detection model, unsupervised domain adaptation (UDA) technology may be used. In a training process, UDA may ensure performance for an unlabeled data distribution by using domain generalization technology or domain adaptation technology. In addition, an object detection model using light detection and ranging (LiDAR) may reliably predict a 3D object in an unlabeled benchmark data set through a UDA methodology using data augmentation or domain alignment, and this technology may be applied to cameras as well. Unlike LiDAR sensors, cameras may cause depth information errors due to the internal/external impacts on the cameras. To solve these depth information errors, a text- or LiDAR-guided object detection model may be used.

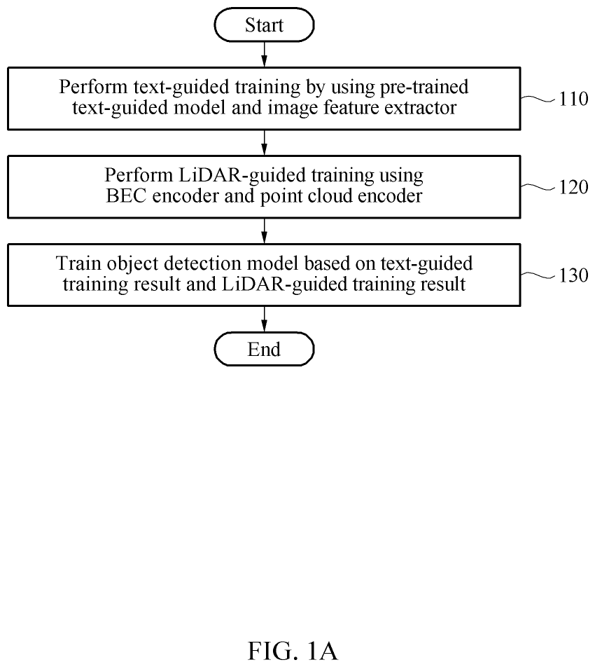

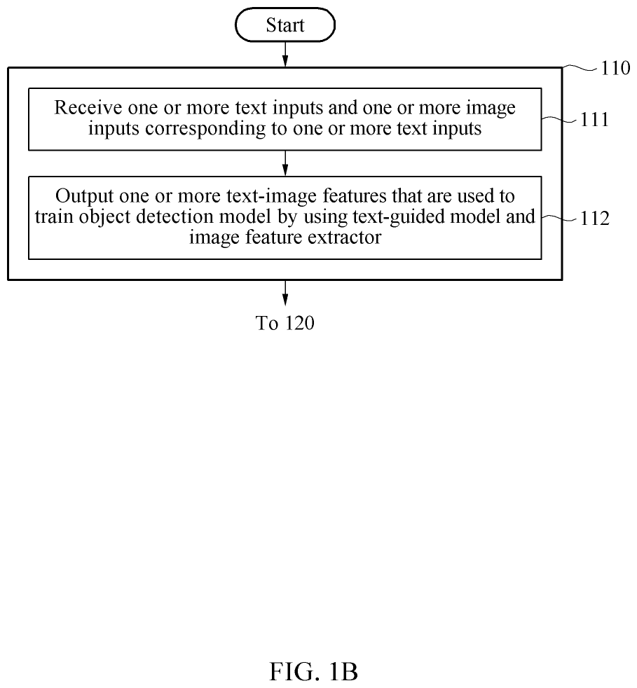

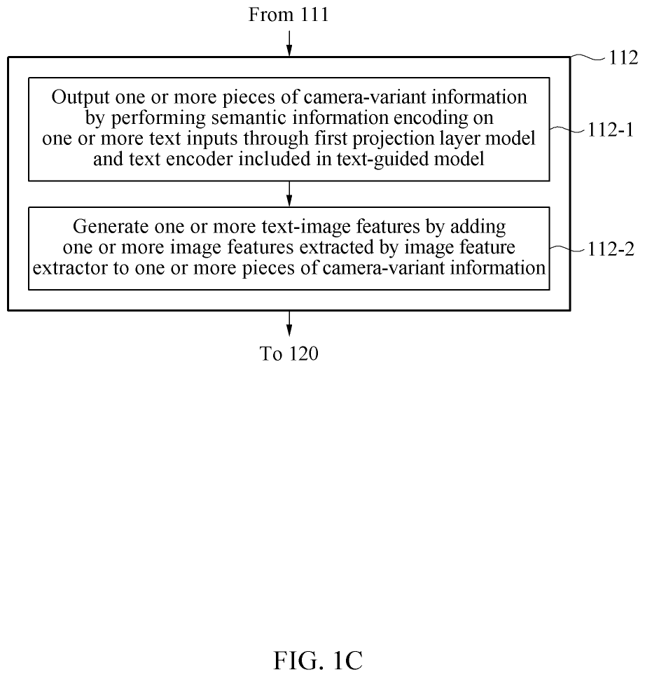

FIGS. 1A to 1C illustrate example methods of training an object detection model according to one or more embodiments.

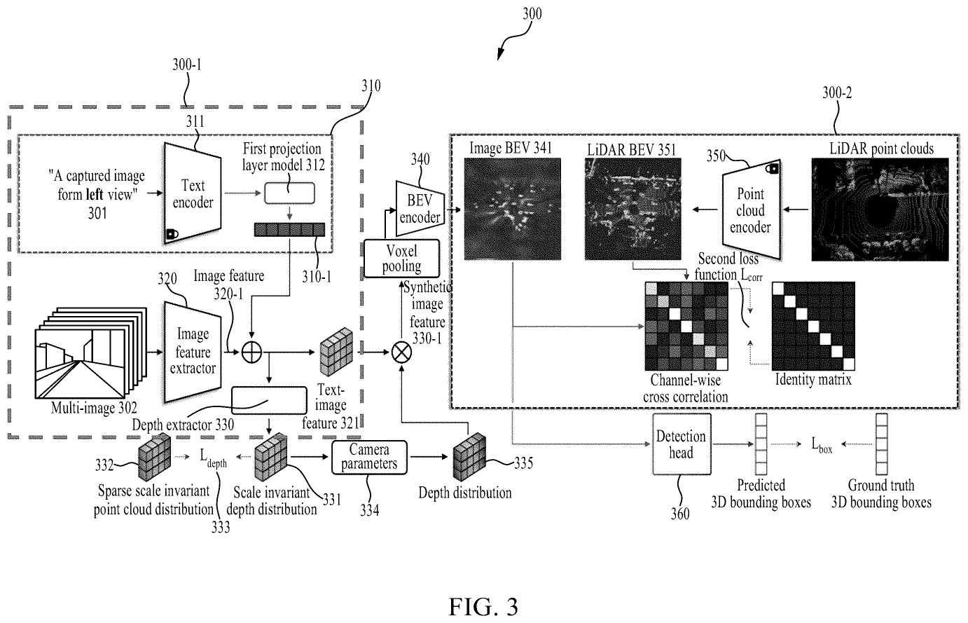

For ease of description, operations 110 to 130, 111, 112, 112-1, and 112-2 are described as being performed by using an object detection model training apparatus 300 illustrated in FIG. 3. However, these operations 110 to 130, 111, 112, 112-1, and 112-2 may be performed by another suitable electronic device in a suitable system.

Furthermore, the operations of FIG. 1 may be performed in the shown order and manner. However, the order of some operations may change, or some operations may be omitted without departing from the spirit and scope of the shown example. The operations illustrated in FIG. 1 may be performed in parallel or simultaneously.

Hereinafter, the text- or LiDAR-guided object detection model is described.

Operations 110 to 140 of FIG. 1A to 1C are described together with reference to FIG. 3.

FIG. 3 illustrates an example object detection model training apparatus according to one or more embodiments.

Referring to FIG. 3, in a non-limiting example, the object detection model training apparatus 300 may perform a text-guided training operation 300-1 for training an object detection model that has been adapted to various environments by providing the generalized semantic information of text to a network (e.g., a text-guided model 310, an image feature extractor 320, a depth extractor 330, a BEV encoder 340, or a detection head 360) included in the object detection model to solve a depth information error issue caused due to differences in camera parameters. In addition, the object detection model training apparatus 300 may perform a LiDAR-guided training operation 300-2 by using a LiDAR-guided model for performing contrastive training that improves unclear depth between image BEVs 341 and LiDAR BEVs 351 by using the BEV encoder 340 and a point cloud encoder 350.

Referring to FIG. 1A, in a non-limiting example, in operation 110, the object detection model training apparatus 300 of FIG. 3 may perform the text-guided training operation 300-1 by using a pre-trained text-guided model 310 and the image feature extractor 320. For this, the text-guided model 310 may include a text encoder 311 and a first projection layer model 312.

A projection layer model may be a linear projection model and may be configured by using a multi-layer perceptron (MLP). In an example, the text encoder 311 may be a CLIP (contrastive language-image pre-training) text encoder, and the CLIP text encoder may understand a text representation that may be directly compared with a visual data representation and may generate text.

A text encoder may perform semantic information encoding and may generate camera-variant information. Semantic information encoding may refer to a method of capturing meaning from data or signals and expressing the captured meaning. Semantic information encoding may be mainly used for natural language processing (NLP), image recognition, or the like. A computer system may extract meaning from complex data, such as words, sentences, or images, and may understand the extracted meaning through semantic information encoding. The text encoder may include an artificial neural network model that performs semantic information encoding by learning vector representations of words from text data. The text encoder may capture semantic relationships between words and may convert each of the words into a vector in a high-dimensional space. The converted vectors may mathematically express the similarities and relationships between the words. By doing so, operations (e.g., ‘King’−‘Man’+‘Woman’=‘Queen’) like algebraic operations may be performed between texts.

In an example, the image feature extractor 320 may be implemented by using an artificial neural network model. The image feature extractor 320 may extract features by learning a spatial hierarchy structure of images and may use the extracted features for classification, detection, segmentation, or other tasks.

In an example, the text-guided model 310 may understand a text representation that may be directly compared with a visual data representation and may generate text features 310-1. The text-guided model 310 may be pre-trained through contrastive training (e.g., L_{cont} of Equations 1 and 2 as described below) to embed further reliable camera-variant information. In addition, a camera classifier (e.g., Lₑₑ of Equation 3 below) may be used for explicit camera recognition.

Referring to FIG. 1B, in a non-limiting example, in operation 111, the object detection model training apparatus 300 of FIG. 3 may receive one or more text inputs 301 and one or more image inputs 302 corresponding to the one or more text inputs 301. The object detection model training apparatus 300 may receive an input of a text-image pair (e.g., one or more text inputs 301 and one or more image inputs (or multi-images (302).

In operation 112, the object detection model training apparatus 300 may output one or more text-image features 321 used to train the object detection model by using the text-guided model 310 and the image feature extractor 320.

The input of a text-image pair may be an input that matches text with images received from one or more cameras. When the object detection model training apparatus 300 receives images from one or more cameras that simulate an omnidirectional LiDAR system, each of the images may be paired with a text prompt including camera information (e.g., a car image captured from a camera front left view).

An image may be passed through the image feature extractor 320 and extracted as image features 320-1, and a text may be extracted as the text features 310-1 (or camera-variant information), including semantic information including the camera-variant information by using the text-guided model.

Referring to FIG. 1C, in a non-limiting example, in operation 112-1, the object detection model training apparatus 300 of FIG. 3 may output one or more pieces of camera-variant information (or the text features 310-1) by performing semantic information encoding on the one or more text inputs 301 through the text encoder 311 and the first projection layer model 312, which are included in the text-guided model.

In operation 112-2, the object detection model training apparatus 300 may generate the one or more text-image features 321 by adding one or more image features 320-1 extracted by the image feature extractor 320 to the one or more pieces of camera-variant information.

Referring back to FIG. 1A, in operation 120, the object detection model training apparatus 300 of FIG. 3 may perform the LiDAR-guided training operation 300-2 that uses the BEC encoder 340 and the point cloud encoder 350.

The LiDAR-guided training operation 300-2 may be performed by using the LiDAR-guided model. In an example, the LiDAR-guided model may perform contrastive training on the LiDAR BEVs 351 obtained from the point cloud encoder 350 and the image BEVs 341 generated based on the BEV encoder 340. In contrastive training, the LiDAR-guided model may learn a cross-correlation of the LiDAR BEVs 351 and the image BEVs 341 based on a second loss function.

Precise geometric information included in a LiDAR point cloud may complement a rich semantic red, green, and blue (RGB) image. Accordingly, a relationship between the LiDAR BEVs 351 generated through the point cloud encoder 350 and the image BEVs 341 generated through the BEV encoder 340 may be represented by Equation 1 below.

In an example, the BEV encoder 340 may extract image BEVs 341 from a synthetic image feature 330-1. In this case, the synthetic image feature 330-1 may be generated by synthesizing the text-image features 321 with a depth feature (or depth distribution) 335 extracted from the depth extractor 330. In addition, voxel pooling may be performed before generating the image BEVs 341. The voxel pooling may be used for 3D data processing, such as 3D deep learning, e.g., a point cloud. The voxel pooling may decrease computational complexity while maintaining an important spatial hierarchy by aggregating the features of a high-resolution 3D space with a low resolution. The voxel pooling may be useful for achieving translation invariance to a certain degree by down-sampling an input volume and simplifying an amount of information.

In an example, the depth extractor 330 may generate first depth information 331 (or a scale-invariant depth distribution) based on the one or more text-image features 321 and may be updated based on the first depth information 331, second depth information 332 generated from a depth extraction point cloud, and a depth loss function L_{depth} 333. Then, the depth extractor 330 may extract the depth feature 335 based on camera parameters 334.

In other words, the BEV encoder 340 may generate the image BEVs 341 based on the synthetic image feature 330-1 generated based on the depth feature 335 extracted by using the depth extractor 330.

$${ℒ}_{feat} = \frac{1}{N} {\sum }^{N} {( {BEV}_{img} - {BEV}_{LiDAR} )}^{2} \qquad Equation 1$$

In Equation 1, BEV_{img} and BEV_{LiDAR} denote the image BEVs 341 generated by the BEV encoder 340 receiving the synthetic image feature 330-1 and the LiDAR BEVs 351 generated by the point cloud encoder 350, respectively. In Equation 1, L_{feat} may express an RGB-based BEV feature in a grid manner, but an L1/L2 distance-based feature extraction technique may have a negative impact on training since the technique transmits modal-specific errors caused by uncertain modal information.

Accordingly, the LiDAR-guided model may perform cross-modal redundancy regularization by using a second loss function L_{corr} as shown in Equations 2 and 3 below.

$${ℒ}_{corr} {=}^{Δ} {\sum }_{i} {( 1 - {𝒞}_{ii} )}^{2} + λ {\sum }_{i} {\sum }_{j \neq i} {𝒞}_{ij}^{2} \qquad Equation 2$$

$${𝒞}_{ij} {=}^{Δ} \frac{{\sum }_{b} {𝓏}_{b , i}^{A} {𝓏}_{b , j}^{B}}{\sqrt{{\sum }_{b} {( {𝓏}_{b , i}^{A} )}^{2}} \sqrt{{\sum }_{b} {( {𝓏}_{b , j}^{B} )}^{2}}} , \qquad Equation 3$$

In Equations 2 and 3, a term including Cii is an invariance term that makes diagonal elements a complete correlation (that is, 1), and a term including Cij is a redundancy reduction term that makes off-diagonal elements an incomplete correlation (that is, 0) (refer to a channel-wise cross-correlation and an identity matrix of FIG. 3).

Here, C denotes a square matrix between −1 (that is, a perfect anti-correlation) and 1 (that is, a perfect correlation). Specifically, an invariance term may improve the robustness of an ambiguous boundary between the foreground and background of the image BEVs 341. A redundancy reduction term may control inappropriate cross-modal information. As a result, L_{corr} may induce the reliable generation of BEV images from various input images through optimized translation training between multi-modalities in a shared embedding space.

The object detection model training apparatus 300 may train the image feature extractor 320, the depth extractor 330, the BEV encoder 340, or the detection head 360 by performing the LiDAR-guided training operation 300-2 through the LiDAR-guided model that performs cross-modal redundancy regularization and may further clearly generate the image BEVs 341 generated from the synthetic image feature 330-1.

In an example, the detection head 360 may extract predicted 3D bounding boxes (or predicted object detection results) with the image BEVs 341 as an input and may update the detection head 360 based on the extracted predicted 3D bounding boxes, ground-truth 3D bounding boxes (e.g., labeled actual object detection results), and a detection loss function L_{box}.

Referring back to FIG. 1A, in a non-limiting example, in operation 130, the object detection model training apparatus 300 of FIG. 3 may train the object detection model based on the text-guided training operation 300-1 and the LiDAR-guided training operation 300-2. In conclusion, as described above, the object detection model training apparatus 300 may update at least one of the image feature extractor 320, the depth extractor 330, the BEV encoder 340, and the detection head 360 based on the one or more text-image features 321 or contrastive training results (or LiDAR-guided training results).

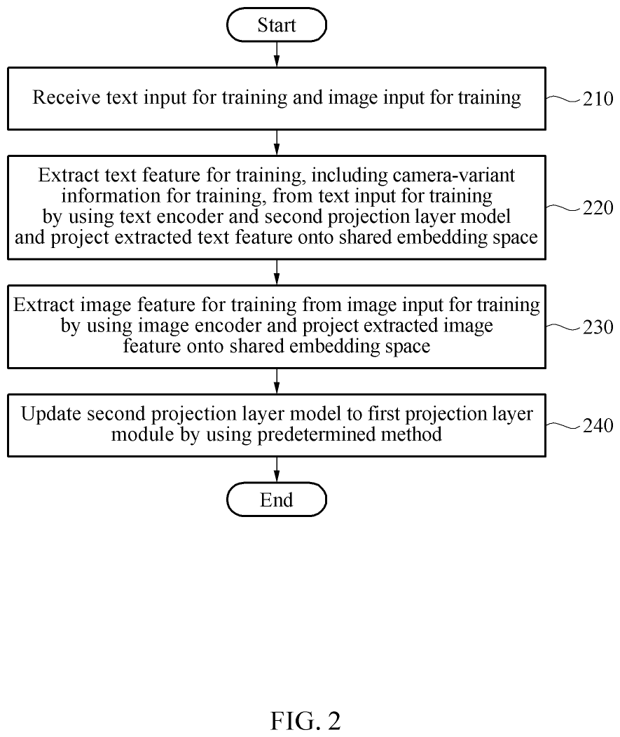

FIG. 2 illustrates an example method of a text-guided model training apparatus according to one or more embodiments.

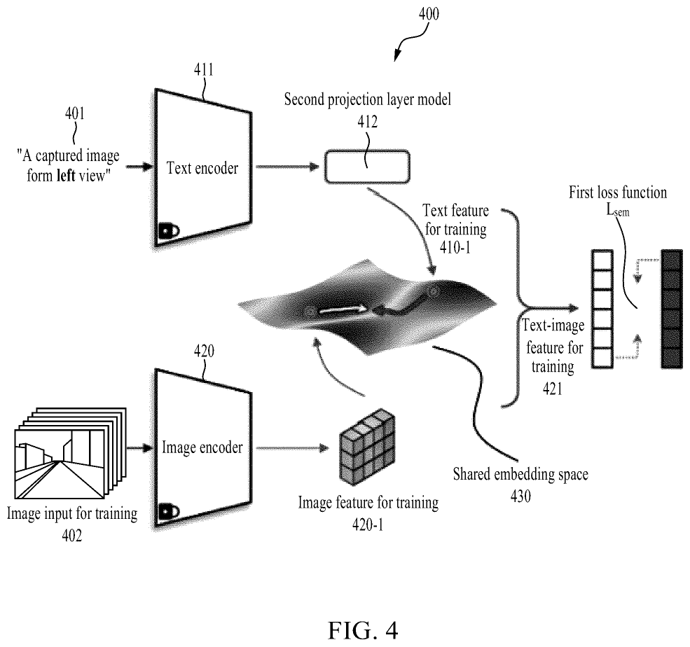

The description provided with reference to FIGS. 1A to 1C may apply to FIG. 2, and any repeated description related thereto may be omitted. In addition, for ease of description, the operation of the text-guided model training apparatus of FIG. 2 is described together with reference to the text-guided model training apparatus 400 of FIG. 4.

In an example, the object detection model training apparatus 300 may obtain the text-guided model 310 before starting object detection model training through the text-guided model training apparatus 400 included therein or may receive the pre-trained text-guided model 310 from the text-guided model training apparatus 400 that is separate therefrom.

The pre-trained text-guided model 310 trained from the text-guided model training apparatus 400 may convert a text input into an embedding that captures the semantic meaning of text such that the object detection model containing the pre-trained text-guided model 310 may perform a wide range of visual and linguistic tasks without training by tasks.

2D visual embeddings and densely aligned CLIP text encoders (e.g., the text encoder 311 and a text encoder 411) may not capture 3D geometric information from semantic text prompts from time to time. Accordingly, to obtain further accurate 3D geometric information, the pre-trained text-guided model 310 may be needed.

Referring to FIG. 4, in a non-limiting example, together, to obtain the pre-trained text-guided model 310 of FIG. 3, the text-guided model training apparatus 400 may pre-train (or fine-tune) a second projection layer model 412 by using the text encoder 411 (e.g., the text encoder 311 of FIG. 3) and an image encoder 420.

More specifically, the pre-trained text-guided model 310 may be obtained in a text-guided model training method that updates the second projection layer model 412 to the first projection layer model 312 by using the text encoder 411, the second projection layer model 412, and the image encoder 420.

Referring to FIG. 2, in a non-limiting example, in operation 210, the text-guided model training device 400 of FIG. 4 may receive a text input 401 for training and an image input 402 for training. In this case, the text input 401 for training and the image input 402 for training may be a text-image pair input for training.

In operation 220, the text-guided model training apparatus 400 may extract a text feature 410-1 for training (including camera-variant information for training) from the text input 401 for training by using the text encoder 411 and the second projection layer model 412 and may project the extracted text feature 410-1 onto a shared embedding space 430. The second projection layer model 412 may be a projection layer model before being updated (or tuned) to a first projection layer model.

The text-guided model training apparatus 400 may encode the text feature 410-1 for training (or the camera-variant information for training) and an image feature 420-1 for training from each text-image pair (e.g., the text input 401 for training and the image input 402 for training). Here, an input of a text-image pair may be expressed by I(image)={i1, i2, . . . , in}, T(text)={t1, t2, . . . , tn}.

In operation 230, the text-guided model training apparatus 400 may extract the image feature 420-1 for training from the image input 402 for training by using the image encoder 420 and may project the extracted image feature 420-1 onto the shared embedding space 430.

The text-guided model training apparatus 400 may project each feature onto the shared embedding space 430 from inputs I and T by using V (e.g., the image encoder 420), the text encoder 411, and the second projection layer model 412. Then, through contrastive alignment training and a camera classifier (e.g., Equations 4 to 6 below), only the second projection layer model 412 may update a gradient.

In operation 240, the text-guided model training apparatus 400 may update the second projection layer model 412 to the first projection layer model 312 by using a predetermined method. In an example, the predetermined method may be a method of performing contrastive alignment training on text feature 410-1 for training and image feature 420-1 for training in the shared embedding space 430 and training the second projection layer model 412 to the first projection layer model 312 by using contrastive alignment training results and a first loss function. The first loss function may include a camera classifier configured to suppress unclear geometric noise in the text feature 410-1 for training.

Hereinafter, the operation of the text-guided model training apparatus is described in detail with reference to equations.

Referring back to FIG. 4, in an example, the text-guided model training apparatus 400 may extract the text feature zt 410-1 through the text encoder 411 and the second projection layer model 412 to obtain the text-guided model 310. The text-guided model training apparatus 400 may extract the image feature zi 420-1 through the image encoder 420. Then, the text-guided model training apparatus 400 may project the extracted text feature zt 410-1 and the extracted image feature zi 420-1 onto the shared embedding space 430 and may perform contrastive alignment between the extracted text feature zt 410-1 and the extracted image feature zi 420-1 according to L_{cont} of Equations 4 and 5 below.

$${ℒ}_{cont}^{{𝓏}_{t} ↔ {𝓏}_{i}} = \frac{1}{N} {{\sum }_{i = 1}}^{N} ( {l}_{sim}^{{𝓏}_{t} \to {𝓏}_{i}} + {l}_{sim}^{{𝓏}_{i} \to {𝓏}_{t}} ) \qquad Equation 4$$

$${l}_{sim}^{a \to b} = - log \frac{exp ( 〈 {a}_{i} , {b}_{i} 〉 ) / τ}{{\sum }_{j} exp ( 〈 {a}_{i} , {b}_{i} 〉 ) / τ} \qquad Equation 5$$

In Equation 4, [symbol] [symbol] denotes a cosine similarity and t denotes a temperature parameter. In addition, to further explicitly learn camera-variant information, the text-guided model training apparatus 400 may use a camera classifier like Equation 6 below.

$${ℒ}_{CE} = - \frac{1}{N} {\sum }_{i = 1}^{N} {\sum }_{c = 1}^{C} {𝒯}_{b} ( {𝓏}_{t} ) log ( {𝒯}_{b} ( {𝓏}_{t} ) ) \qquad Equation 6$$

In Equation 6, Cϵ [symbol] ^{N×N}^{_{I}} denotes a multi-view deployment label. The camera classifier may suppress unclear geometric noise and may help train the camera-variant information. The text-guided model training apparatus 400 may optimize the second projection layer model 412 through the first loss function like Equation 7 below.

$${ℒ}_{sem} = {λ}_{cont} {ℒ}_{cont} + {λ}_{CE} {ℒ}_{CE} \qquad Equation 7$$

In Equation 7, λ_{cont} and λ_{CE} are hyperparameters to switch text-guided information. The text encoder 411 and the image encoder 420 may not be trained, and only the second projection layer model 412 may be trained. The second projection layer model 412, which has been completely trained, may be the first projection layer model 312 that is pre-trained (or tuned). Accordingly, the text-guided model training apparatus 400 may obtain the text-guided model 310, including the text encoder 311 or 411 and the first projection layer model 312.

Referring back to FIG. 3, in an example, the pre-trained text-guided model 310 may output camera-variant information. The camera-variant information may be extracted from text, including camera information. Specifically, the camera-variant information output by the text-guided model 310 may embed the information of a certain scene by cameras into an image feature.

In an example, it is assumed that text “t1=A car image captured from camera front view” includes camera-variant information. Here, “camera front view” may be the camera-variant information. The text-guided model 310 may be trained through the text-guided model training apparatus 400 to output such camera-variant information through pre-training.

Hereinafter, the operation of said object detection model training apparatus using the pre-trained text-guided model 310 is described.

In an example, the object detection model training apparatus 300 may output camera-variant information (or the text features 310-1) by using the text-guided model 310 and may perform the text-guided training operation 300-1, which uses the object detection model for training by adding the camera-variant information to the image features 320-1 output from the image feature extractor 320.

Features may be projected from an input of a text-image T-I pair onto a shared embedding space (here, the shared embedding space shares the same concept with the shared embedding space of FIG. 4, which is a space for adding camera-variant information to image features) by using the text-guided model 310. Then, under the assumption that each feature embeds semantic information (or camera-variant information) in a high-dimension distributional vector space according to Word2Vec, text and image features may be reflected through the algebraic equation like Equation 8 below.

In other words, a target that the text-guided model 310 aims to extract may be semantic information by cameras including camera-variant information. Accordingly, the text-guided model 310 may be pre-trained by using a text-image pair for training to extract camera-variant information. Then, the text-guided model 310 that may extract camera-variant information which may be used for object detection model training, and the extracted camera-variant information may be augmented through summation which adds extracted text information to existing image features as shown in Equation 8 below.

In an example, the object detection model training apparatus 300 may train an object detection model based on the text-guided training operation 300-1 and the LiDAR-guided training operation 300-2. The object detection model training apparatus 300 may include the pre-trained text-guided model 310, the image feature extractor 320, the depth extractor 330, the BEV encoder 340, and a LiDAR-guided model (including the point cloud encoder 350).

The object detection model training apparatus 300 may receive one or more text inputs and one or more image inputs corresponding to the one or more text inputs, may output one or more text-image features used to train the object detection model by using the pre-trained text-guided model and the image feature extractor, and may train the object detection model based on the one or more text-image features and results of the LiDAR guide model. Each component may be implemented as an artificial neural network model.

The object detection model training apparatus 300 may perform semantic augmentation on image features in the method like Equation 8 below. The object detection model training apparatus 300 may perform semantic augmentation using a text-based camera-variant embedding zt.

$$𝒜 ( {𝓏}_{i} , {𝓏}_{t} ) = {𝓏}_{i} + \frac{{𝓏}_{t}^{t} - {𝓏}_{t}^{s}}{‖ {𝓏}_{t}^{t} - {𝓏}_{t}^{s} {‖}_{2}} \qquad Equation 8$$

In Equation 8, ∥ ∥2 denotes an L2 distance, [symbol] denotes a target embedding, and [symbol] denotes source embedding. The object detection model training apparatus 300 may input multi-view images and text prompts to the text-guided model 310 and the image feature extractor 320 and may project zi and zt onto a shared embedding space (which is conceptually the same as the shared embedding space 430 of FIG. 4). Then, the object detection model training apparatus 300 may generate [symbol] = [symbol] ( [symbol] , [symbol] ) through the random sampling of zt and input the generated [symbol] = [symbol] ( [symbol] , [symbol] ) to a view transformer.

The view transformer may be technology for projecting existing 2D features onto a 3D BEV space together with environmental information. A depth distribution may be extracted by inputting the existing 2D features extracted through an image backbone to a depth estimation network (e.g., the depth extractor 330), and the extracted depth distribution may form a 3D depth volume by performing an outer product function with the existing 2D features. Then, the existing 2D features and/or the 3D depth volume may be projected onto the 3D BEV space.

As described above, the object detection model training apparatus 300 may learn data through data augmentation in various environments and distorted environments.

In conclusion, the object detection model training apparatus 300 may perform domain generalization on an input of a text-image pair in the shared embedding space (which is conceptually the same as the shared embedding space 430) through the text-guided training operation 300-1 and may obtain camera-variant information. The object detection model training apparatus 300 may secure various pieces of data by performing semantic data augmentation on the obtained camera-variant information. The various pieces of data secured as such may be learned again by the image feature extractor 320, the BEV encoder 340, the depth extractor 330, and the detection head 360 such that the object detection model for performing object detection in various environments may be obtained.

The object detection model training apparatus 300 may parallelly or sequentially repeat said text-guided training operation 300-1 and said LiDAR-guided training operation 300-2 and may update artificial neural network models included in the object detection model.

Hereinafter, an exemplary training process for the operation of the object detection model training apparatus 300 is described.

In an example, it is assumed that an image is an image received from a camera mounted to the left side of a vehicle. In this case, an input of a text-image pair may be ‘image captured from the left-side camera’-‘left-side image’. The text-guided model 310 may generate left-side camera-variant information through the semantic information encoding of the text ‘image captured from the left-side camera’.

In the text-guided model training operation, the object detection model training apparatus 300 may perform semantic augmentation of the generated left-side camera-variant information on image features. The image feature extractor 320 may extract left-side image features from ‘left-side image’. The object detection model training apparatus 300 may perform semantic augmentation on the image features by adding the left-side camera-variant information to the left-side image features.

The text-image features 321 may be input to the depth extractor 330 such that a depth may be extracted. In this case, the depth extractor 330 may be trained by using a depth loss function, based on augmented data.

The extracted depth may be operated again with the text-image features 321, and the BEV encoder 340 may generate image BEVs 341 based on the synthetic image feature 330-1. The object detection model training apparatus 300 may perform voxel pooling before generating the image BEVs 341.

The detection head 360 may perform object detection based on the image BEVs 341. In this case, the detection head 360 may be trained based on a detection loss function.

In the LiDAR-guided training operation 300-2, the object detection model training apparatus 300 may update the BEV encoder 340, the detection head 360, the depth extractor 330, and the first image feature extractor 320 by using the cross-correlation of the LiDAR BEVs 351 and the image BEVs 341 and the second loss function.

The object detection model training apparatus 300 may train the artificial neural network models of the object detection model training apparatus 300 through backpropagation by using the results of the text-guided training operation 300-1 and the LiDAR-guided training operation 300-2.

Referring back to FIG. 4, in an example, one or more blocks and a combination thereof may be implemented by a special-purpose hardware-based computer that performs a predetermined function or a combination of computer instructions and special-purpose hardware.

The description provided with reference to FIGS. 1A to 3 may apply to FIG. 4, and any repeated description related thereto may be omitted.

The text-guided model training apparatus 400 may pre-train (or fine-tune) the second projection layer model 412 by using the text encoder 411 (e.g., the text encoder 311 of FIG. 3) and the image encoder 420 to obtain the pre-trained text-guided model 310. The text input 401 for training may be projected as text feature 410-1 for training onto the shared embedding space 430 through the text encoder 411 and the second projection layer model 412. The image input 402 for training may be projected as image feature 420-1 for training onto the shared embedding space 430 through the image encoder 420. The projected text feature 410-1 for training and the projected image feature 420-1 for training may update the second projection layer model 412 to the first projection layer model 312 based on a camera classifier and the first loss function.

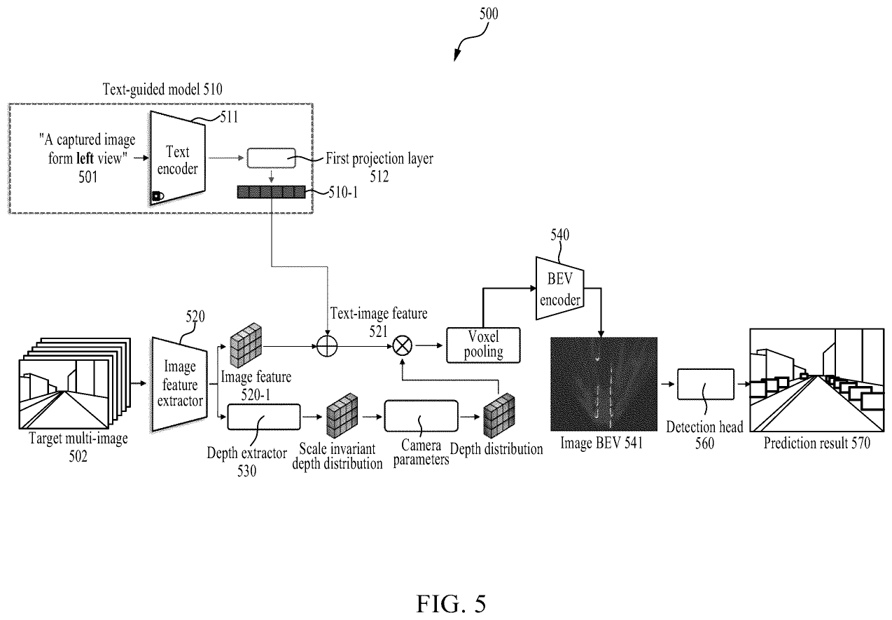

FIG. 5 illustrates an example operation of the object detection model training apparatus according to one or more embodiments.

Referring to FIG. 5, in a non-limiting example, one or more blocks and a combination thereof may be implemented by a special-purpose hardware-based computer that performs a predetermined function or a combination of computer instructions and special-purpose hardware.

The description provided with reference to FIGS. 1A to 4 may apply to FIG. 5, and any repeated description related thereto may be omitted.

In an example, an object detection model 500 trained by the object detection model training apparatus 300 may perform object detection based on a pre-trained text-guided model 510 (e.g., the text-guided model 310 of FIG. 3), an image feature extractor 520, a depth extractor 530, and a BEV encoder 540, and a detection head 560.

In addition, through the text-guided model 510 including a text encoder 511 (e.g., the text encoder 311 of FIG. 3 or the text encoder 411 of FIG. 4) and a first projection layer model 512, camera-variant information may be reflected to be used for object detection.

A target image of a target multi-images 502 is assumed to be an image received from a camera mounted to the left side of a vehicle. In this case, an input of a text-image pair may be ‘image captured from the left-side camera’-‘left-side image’. The text-guided model 510 may generate left-side camera-variant information 510-1 through the semantic information encoding of a text input 501, which is ‘image captured from the left-side camera’.

The object detection model 500 may extract the left-side camera-variant information 510-1 generated by using the text-guided model 510 and a left-side image feature 520-1 generated by using the image feature extractor 520. The object detection model 500 may generate a text-image feature 521 by adding data-augmented left-side camera-variant information to the left-side image feature 520-1.

The left-side image feature 520-1 may have its depth information extracted by being input to the depth extractor 530. The extracted depth information may be synthesized again with the text-image feature 521, and the BEV encoder 540 may generate an image BEV 541 based on a synthesized image feature. The detection head 560 may perform object detection based on the image BEV 541 and may output a prediction result 570.

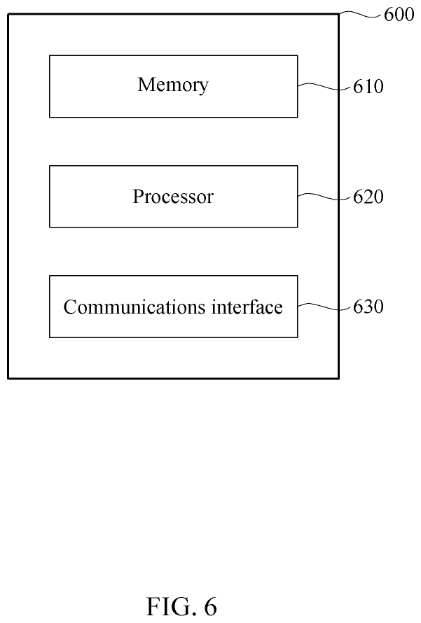

FIG. 6 illustrates an example electronic device according to one or more embodiments.

Referring to FIG. 6, in a non-limiting example, one or more blocks and a combination thereof may be implemented by a special-purpose hardware-based computer that performs a predetermined function or a combination of computer instructions and special-purpose hardware. The description provided with reference to FIGS. 1A to 5 may also apply to FIG. 6. In an example, an electronic device 600 may include at least one of the object detection model training apparatus 300 and the text-guided model training apparatus 400.

The electronic device 600 may include a memory 610 and a processor 620. The electronic device 600 may further include a communication interface (e.g., an I/O interface), and the communication model may include a transmitter and a receiver.

The electronic device 600, in an example, may include the memory 610 and the processor 620 connected to the memory 610 through a system bus or another suitable circuit.

The memory 610 may include computer-readable instructions. The processor 620 may be configured to execute computer-readable instructions, such as those stored in the memory 610, and through execution of the computer-readable instructions, the processor 620 is configured to perform one or more, or any combination, of the operations and/or methods described herein. The memory 610 may be a volatile or nonvolatile memory.

For example, the memory 610 may store the program code such that the processor 620 may perform at least one operation described with reference to FIGS. 1A to 5.

Depending on the type of apparatus to be implemented, the electronic device 600 may include components less than the number of the illustrated components or may include additional components that are not illustrated in FIG. 6. Also, at least one component may be included in another component and may constitute a portion of the other component.

The processor 620 may further execute programs, and/or may control the object detection model training apparatus 300 and/or object detection model training, and may include any one or a combination of two or more of, for example, a central processing unit (CPU), a graphic processing unit (GPU), a neural processing unit (NPU) and tensor processing units (TPUs), but is not limited to the above-described examples.

In an example, the processor 620 may drive the pre-trained text-guided model 310, the image feature extractor 320, the BEV encoder 340, the LiDAR-guided model, which includes the point cloud encoder 350, and the detection head 360. The processor 620 may cause the object detection model training apparatus 300 to receive one or more text inputs and one or more image inputs corresponding to the one or more text inputs, may output one or more text-image features used to train the object detection model by using the pre-trained text-guided model and the image feature extractor, and may train the object detection model based on the one or more text-image features and results of the LiDAR guide model.

The processor 620 may include the text encoder 411, the second projection layer model 412, and the image encoder 420. The processor may cause the text-guided model training apparatus to receive a text input and an image input, extract a text feature, which includes camera-variant information, from the text input by using the text encoder and the second projection layer model and project the extracted text feature onto the shared embedding space 430, extract an image feature from the image input by using the image encoder and project the extracted image feature onto the shared embedding space, and obtain the pre-trained text-guided model 310 by updating the second projection layer model to the first projection layer model 312 by using a predetermined method.

The communication interface 630 (e.g., an I/O interface) may include user interface may provide the capability of inputting and outputting information regarding the object detection model training apparatus 300, the electronic device 600, and other devices. The communication interface 630 may include a network module for connecting to a network and a module for forming a data transfer channel with a mobile storage medium. In addition, the user interface may include one or more input/output devices, such as the display device 630, a mouse, a keyboard, a speaker, or a software module for controlling the input/output device. The neural networks, processors, memories, electronic devices, electronic

apparatuses, the object detection model training apparatus 300, text-guided model 310, text encoder 311, first projection layer model 312, image feature extractor 320, depth extractor 330, BEV encoder 340, point cloud encoder 350, detection head 360, text-guided model training apparatus 400, text encoder 411, image encoder 420, object detection model 500, text guided model 510, image feature extractor 520, depth extractor 530, BEV encoder 540, detection heard 560, electronic device 600, memory 610, processor 620, and communications interface 630 described herein and disclosed herein described with respect to FIGS. 1-6 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
text-guided training using a pre-trained text-guided model and an image feature extractor based on one or more text inputs and one or more image inputs corresponding to the one or more text inputs;
light detection and ranging (LiDAR)-guided training using a point cloud encoder and a bird's-eye view (BEV) encoder; and
training an object detection model based on a result of the text-guided training and a result of the LiDAR-guided training,
wherein the text-guided training comprises:
outputting one or more text-image features that are used to train the object detection model by using the text-guided model and the image feature extractor.

2. The method of claim 1, wherein the outputting the one or more text-image features comprises:
outputting camera-variant information by performing semantic information encoding on the one or more text inputs through a text encoder and a first projection layer model, which are comprised in the text-guided model; and
generating the one or more text-image features by adding one or more image features extracted by the image feature extractor to the camera-variant information.

3. The method of claim 1, wherein the LiDAR-guided training comprises:
performing contrastive training on LiDAR BEVs obtained from the point cloud encoder and image BEVs generated based on the BEV encoder.

4. The method of claim 3, wherein the contrastive training comprises:
training a cross-correlation of the LiDAR BEVs and the image BEVs based on a second loss function.

5. The method of claim 3, wherein the training the object detection model comprises:
updating one or more of the image feature extractor, a depth extractor, the BEV encoder, and a detection head, based on one of the one or more text-image features or a result of the contrastive training.

6. The method of claim 5, wherein the depth extractor is configured to generate first depth information based on the one or more text-image features, and
wherein the depth extractor is updated based on the first depth information, second depth information generated from a depth extraction point cloud, and a depth loss function.

7. The method of claim 6, wherein the BEV encoder is configured to generate the image BEVs based on a synthetic image feature generated based on a depth feature extracted by using the depth extractor and the one or more text-image features.

8. The method of claim 1, further comprising:
text-guided model training to obtain the pre-trained text guided model, the text-guided model training including updating a second projection layer model to a first projection layer model by using a text encoder, the second projection layer model, and an image encoder.

9. The method of claim 8, wherein the text-guided model training comprises:
extracting a text feature for training, the text feature comprising camera-variant information for training, from a training text input by using the text encoder and the second projection layer model and projecting the extracted text feature for training onto a shared embedding space;
extracting an image feature for training from a training image input by using the image encoder and projecting the extracted image feature for training onto the shared embedding space; and
updating the second projection layer model to the first projection layer model.

10. The method of claim 9, wherein the updating the second projection layer model comprises:
performing contrastive alignment training on the text feature for training and the image feature for training in the shared embedding space; and
training the second projection layer model to the first projection layer model by using a result of the contrastive alignment training and a first loss function.

11. The method of claim 10, wherein the first loss function comprises:
a camera classifier configured to suppress unclear geometric noise in the text feature for training.

12. A non-transitory computer-readable storage medium storing instructions that, when executed by one or more processors, configure the one or more processors to perform a text-guided object detection model, the text guided object detection model comprising:
a pre-trained text-guided model configured to generate camera-variant information from a text-image pair;
an image feature extractor configured to extract an image feature from the text-image pair;
a depth extractor configured to extract depth information based on the image feature;
a BEV encoder configured to generate an image bird's-eye view (BEV) based on the camera-variant information, the image feature, and the depth information; and
a detection head configured to perform object detection based on the image BEV.

13. An electronic apparatus, the apparatus comprising:
one or more processors configured to drive a pre-trained text-guided model, an image feature extractor, a bird's-eye view (BEV) encoder, a light detection and ranging (LiDAR)-guided model, which comprises a point cloud encoder, and a detection head; and
a memory storing instructions, wherein an execution of the instructions configures the processors to:
receive one or more text inputs and one or more image inputs corresponding to the one or more text inputs and output one or more text-image features used to train an object detection model by using the pre-trained text-guided model and the image feature extractor; and
train the object detection model based on the one or more text-image features and a result of the LiDAR-guided model.

14. The apparatus of claim 13, wherein the pre-trained text-guided model is configured to generate one or more pieces of camera-variant information by performing semantic information encoding on the one or more text inputs through a text encoder and a first projection layer model, and
wherein the one or more text-image features are generated by adding one or more image features extracted by the image feature extractor to the one or more pieces of camera-variant information.

15. The apparatus of claim 13, wherein the LiDAR-guided model comprises:
a model configured to perform contrastive training on LiDAR BEVs obtained from the point cloud encoder and image BEVs obtained from the BEV encoder.

16. The apparatus of claim 15, wherein the contrastive training comprises:
training the object detection model by training a cross-correlation of the LiDAR BEVs and the image BEVs based on a second loss function.

17. The apparatus of claim 15, wherein the one or more processors are further configured to
update one or more of the image feature extractor, a depth extractor, the BEV encoder, and a detection head, based on the one or more text-image features or a result of the contrastive training.

18. An electronic apparatus, comprising:
one or more processors comprising a text encoder, a second projection layer model, and an image encoder; and
a memory storing instructions, wherein an execution of the instructions, configures the processors to:
extract a text feature, which comprises camera-variant information, from text by using the text encoder and the second projection layer model and project the extracted text feature onto a shared embedding space;
extract an image feature from an image by using the image encoder and project the extracted image feature onto the shared embedding space; and
obtain a pre-trained text-guided model by updating the second projection layer model to a first projection layer model.

19. The electronic apparatus of claim 18, wherein the obtaining the pre-trained text guided model comprises:
performing contrastive alignment training on the text feature and the image feature in the shared embedding space; and
training the second projection layer model to the first projection layer model by using a result of the contrastive alignment training and a first loss function.

20. The electronic apparatus of claim 19, wherein the first loss function comprises:
a camera classifier configured to suppress unclear geometric noise in the text feature for training.
